(19) United States
(12) Patent Application Publication
(10) Pub. No.: US 2015/0144829 A1
(43) Pub. Date: May 28, 2015

(54) COMPOSITION IN THE FORM OF A DISPERSION COMPRISING A LIGNIN, A METHOD FOR THE MANUFACTURING THEREOF AND USE THEREOF

(71) Applicant: Stora Enso OYJ, Helsinki (FI)

(72) Inventor: Henri J.M. Grünbauer, Amersfoort (NL)

(21) Appl. No.: 14/404,284

(22) PCT Filed: May 30, 2013
(86) PCT No.: PCT/IB2013/054464

§ 371 Date: Nov. 26, 2014

(30) Foreign Application Priority Data
Jun. 1, 2012 (SE) 1250569-9

(51) Int. Cl. C08J 9/00; C08J 9/14

(52) U.S. Cl. CPC C08J 9/0023; C08J 9/141; C08J 9/0004; C08J 2375/04; C08J 2203/14; C08J 2203/16; C08J 2201/022
USPC 252/62; 106/501.1; 521/99; 521/131; 521/117

(57) ABSTRACT

The present invention relates to a composition in the form of a dispersion, a method for the manufacturing of said composition and uses thereof.

### FIELD OF INVENTION

The present invention relates to a composition in the form of a dispersion a method for the manufacturing of said composition and use thereof in different application areas, such as in adhesives, binders, castings, foams (such as rigid polyurethane and polyisocyanurate foams for thermal insulation in refrigerators and freezers and in building and construction applications, semi-rigid polyurethane foams, spray foams, flexible polyurethane foams moulded as well as laminated, microcellular foams and viscoelastic foams), fillers, glues, sealants, elastomers and rubbers.

The present invention also relates to a method for the manufacturing of a foam and use of this foam.

### BACKGROUND

In recent years, lignin and lignin-based products have become increasingly important in the search for sustainable alternatives to current mineral-oil based products that are known to impact our world's ecological balance in a negative way. An important area that has received attention in this context has been the use of lignin as re-enforcement fillers for a multitude of polymeric materials such as e.g. rubbers, epoxy and urethane-based networks and polymers.

Further, U.S. Pat. No. 3,223,697 discloses powders of lignin and U.S. Pat. No. 5,008,378 discloses lignin dispersions. Additionally, CN1462760 discloses a lignin polyurethane foam and JP2011-184643 a foam using a lignin-based substance.

However none of these documents discloses dispersions of lignin with a particle size enabling use of said dispersions in an efficient method for incorporation of these particles in thermoset and thermoplastic industrial products where the lignin may exert desirable influences as part of the polymeric backbone of such products.

Additionally, there also exists a need for a simple, cost-effective process for the production of lignin particles of submicron and/or nanometer size that are amenable to the production of a multitude of industrial products where these powders may be effective.

### SUMMARY OF THE INVENTION

The present invention solves one or more of the above problems, by providing according to a first aspect a composition in the form of a dispersion, comprising one or more dispersants, and lignin, preferably alkaline lignin, wherein said lignin has an average particle size of from about 100 nm to about 2000 nm, preferably in a range from about 100 to about 1000 nm, most preferred from about 200 to about 600 nm, and wherein said dispersants has a solubility parameter of from about 18 to about 30 MPa^{1/2} and a viscosity of from about 15 mPas to about 20,000 mPas, more preferably from about 15 mPas to about 10,000 mPas, especially preferred from about 20 mPas to about 1000 mPa, most preferred from about 20 mPas to about 500 mPas. The values for the solubility parameters and viscosity are measured or calculated at room temperature.

The present invention also provides according to a second aspect use of a composition according to the first aspect in making foams, rubbers, adhesives, reactive fillers or for use as a filling agent. Said dispersion may e.g. be used in I appliances (such as house hold appliances; e.g. refrigerators and freezers) or building and constructing applications. It may also be used in applications where thermal insulation is required such in refrigerators and freezers. It may also be used in foams (such as spray-foam, rigid-faced and flexible-faced panels produced by double-band lamination, discontinuous panels, block foams, pour-in-place foams and foams for pipe insulation). The foams in these latter panels may be of the polyurethane or the polyisocyanurate type. Said dispersions may also be used in microcellular foams and viscoelastic foams, flexible slabstock and flexible molded polyurethane foams, such as the foams applied in bedding, furniture, footwear (e.g. shoe soles) and automotive applications. Said dispersions may also be used in composites, coatings, binders, sealants, rubbers, adhesives, reactive fillers or may be used as a filling agent. Said dispersions may also be used as reactive fillers/filling agents in polymer castings, such as in epoxy casting or in polyolefin casting.

The present invention also provides according to a third aspect a method for the manufacturing of a composition in the form of a dispersion according to the first aspect comprising the following steps:

i) providing a lignin, preferably an alkaline lignin,

ii) adding one polyol or a mixture of polyols, and

iii) mixing said components thus providing said composition.

The present invention also provides according to a fourth aspect, a composition in the form of a dispersion obtainable by the method according to the third aspect.

The present invention also provides according to a fifth aspect a method for the manufacturing of a foam comprising the following steps:
a) providing a composition according to the first or fourth aspect,
b) adding one or more blowing agents to said composition,
c) optionally adding one or more additives,
d) adding isocyanate to said composition,
e) stirring the mixture obtained in step d) and
f) conveying the stirred mixture in step e) into a mould to provide a foam continuously or discontinuously (i.e. batch-wise).

The present invention also provides according to a sixth aspect, a foam obtainable by the method according to the fifth aspect.

The present invention also provides according to a seventh aspect use of the foam according to the fifth aspect. Said foam may be used in the building and construction segment, in appliances (such as household appliances, e.g. refrigerators and freezers), for thermal insulation, in automotive applications or in furniture or bedding applications. It may also be used in applications where thermal insulation is required such in refrigerators and freezers, in spray-foam, rigid-faced and flexible-faced panels produced by double-band lamination, discontinuous panels, block foams, pour-in-place foams and foams for pipe insulation. The foams in these latter panels may be of the polyurethane or the polyisocyanurate type. Said foams may also as mentioned be used in bedding, furniture and automotive applications (e.g. car seats). Said foams may further be used in footwear (e.g. shoe soles).

### DETAILED DESCRIPTION OF THE INVENTION

It is intended throughout the present description that the expression “lignin” embraces any lignin which may be used for making dispersions. Preferably the lignin is an alkaline lignin. It may e.g. be a Kraft lignin. The lignin may preferably be obtained by using the process disclosed in EP 1794363.

It is intended throughout the present description that the expression “isocyanate” embraces any isocyanate compound suitable for use in foam applications. The isocyanate may be a monomeric diisocynate, polymeric or it may also be an isocyanate prepolymer.

It is intended throughout the present description that the expression “submicron” embraces anything below 2000 nm and down to 1 nm.

It is intended throughout the present description that the expression “flame retardant” embraces any flame retardant useful in foam or filler applications. The flame retardant may be liquid organophosphorous, organohalogen and halogenated organophosphorous flame retardants. TCPP and DEEP are preferred examples.

It is intended throughout the present description that the expression “mould” encompasses any mould which may be used in rigid foam manufacturing. Said mould may e.g. be a mould for in-situ foams (whereby you may use spray technology to convey the material to be moulded; this is a discontinuous technology), a mould for providing a block (which may be both discontinuous and continuous), a mould for making an insulation board (which may be both discontinuous and continuous), a double bend laminator (e.g. for making metal faced sandwich panels; this is further a continuous technology). The above technologies are further described in “The polyurethane book”, 2010, editors David Randall and Steve Lee.

It is intended throughout the present description that the term solubility parameter refers to a property, represented by δ, used within the art of organic, physical and polymer chemistry to describe the solubility of organic compounds in other organic compounds or solvents. Calculate δ from fragment contributions published in the art. [see, for example, Handbook of Solubility Parameters and other Cohesion Parameters, Barten, A., CRC Press, Florida (1984) and Properties of Polymers: their Estimation and Correlation with Chemical Structure, van Krevelen, D. W.; Hoftijzer, P. J., Elsevier, Amsterdam 2nd. edn (1976)]

According to a preferred embodiment of the first aspect of the invention said lignin is a Kraft lignin.

According to a preferred embodiment of the first aspect of the invention said dispersant is a polyol, preferably an ethylene glycol or polyethylene glycol or a combination thereof, most preferred selected from the group comprising PEG (polyethylene glycol), DEG (diethylene glycol), TEG (triethylene glycol) and MEG (monoethylene glycol) or combinations thereof.

According to a preferred embodiment of the first aspect of the invention the polyol is PEG and preferably the PEG has a molecular weight of from about 100 to about 5000, especially preferred from about 100 to about 600, most preferred about 400.

According to a preferred embodiment of the first aspect of the invention said polyol comprises a mixture of different PEGs, wherein said mixture preferably comprises one PEG having a molecular weight of about 400 and one PEG having a molecular weight of about 600.

According to a preferred embodiment of the first aspect of the invention there is provided that said composition also comprises one or more alkanolamines, such as ethanolamine, diethanolamine, propanolamine, monoethanolamine (MEA) or combinations thereof, preferably MEA.

According to a preferred embodiment of the first aspect of the invention there is provided a composition also comprising one or more flame retarding agents, preferably TCPP (Tris (1-chloro-2-propyl)phosphate) or DEEP (diethyl ethyl phosphonate) or a combination of both.

According to a preferred embodiment of the third aspect of the invention one or more flame retarding agents are added before mixing.

According to a preferred embodiment of the third aspect of the invention said mixing is a high shear mixing of at least about 1000 rpm, preferably at least about 5000 rpm, most preferred at least about 20000 rpm.

According to a preferred embodiment of the fifth aspect of the invention said one or more additives may be selected from the group consisting of one or more surfactants, preferably one or more polydimethylsiloxane co-polymers (such as PDMS), one or more polyurethane catalysts, preferably one or more tertiary amines or one or more triamines, one or more flame retarding agents, or combinations thereof.

According to a preferred embodiment of the fifth aspect of the invention one or more hydroxyl-containing compounds and/or one more catalysts are added before addition of said one or more blowing agents, preferably one or more polyester polyols and/or one or more polyether polyols and as a catalyst a trimer catalyst (such as an alkali octoate) are added.

According to a preferred embodiment of the fifth aspect of the invention said one or more blowing agents are one or more hydrocarbon compounds, or other blowing agents known in the art, preferably selected from n-pentane, i-pentane and cyclopentene or a combination thereof.

As set out above in one preferred embodiment, the present invention relates to stable submicron dispersions of Kraft lignin in suitable non-aqueous liquid dispersants and a process for their production.

As set out above the present invention also provides a ready-to-use liquid composition comprising submicron dispersions of Kraft lignin in non-aqueous dispersants that are amenable to further processing steps to produce end-products without the need for further solids handling and tedious solid-liquid wetting and mixing procedures.

The present invention thus provides according to preferred embodiments set out above:
a relatively simple mixing process whereby a Kraft lignin is mixed at sufficient shear rates with suitable dispersants to provide a dispersion,
these dispersants are characterized by their viscosity and solubility parameters only, which enables them to be tuned towards the intended production process whereby the lignin particles are incorporated in the target end-product,
the lignin particles involved are largely of submicron and/or nanometer size which makes them effective as participants in the production process of the end-product.
Thus said process according to the third aspect of the invention delivers these particles in the form of a non-aqueous dispersion that is compatible with the materials taking part in the targeted production process.

Preferred features of each aspect of the invention are as for each of the other aspects mutatis mutandis. The prior art documents mentioned herein are incorporated to the fullest extent permitted by law. The invention is further described in the following examples, together with the appended figure, which do not limit the scope of the invention in any way. Embodiments of the present invention are described as mentioned in more detail with the aid of examples of embodiments, together with the appended figures, the only purpose of which is to illustrate the invention and are in no way intended to limit its extent.

### FIGURES

FIG. 1 discloses size distribution by Intensity for Kraft lignin dispersed in ethylene glycol

FIG. 2 discloses size distribution by Intensity for Kraft lignin dispersed in Polyethylene glycol 400.

FIG. 3 discloses Size distribution by Intensity for Kraft lignin dispersed in Polyethylene glycol 600

FIG. 4 discloses Size distribution by Intensity for Kraft lignin dispersed in 1-Hexanol supernatant

### EXAMPLES

### Example 1

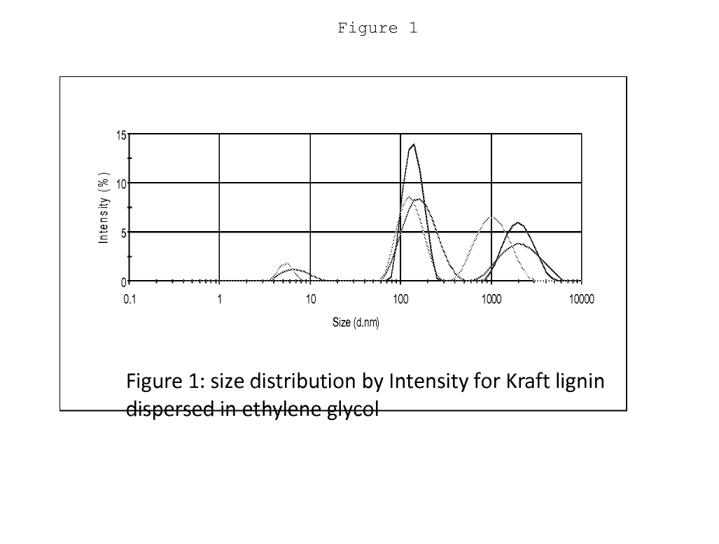

Dispersions at 5, 10 and 15% w/w loading of Kraft lignin in ethylene glycol were prepared using a Heidolph DIAX 900 disperser operated at two rates, initially at 18800 rpm/min for at least 1 minute to disperse the dry lignin, followed by one minute at 25000 rpm to ensure maximum dispersability. Samples taken from these dispersions were about 50-fold diluted prior to measurement of particle size and particle size distribution with a Malvern Zetasizer Nano ZS. This instrument measures the diffusion of particles moving under Brownian motion and converts this to size and size distribution using the Stokes-Einstein relationship. Each sample was scanned 3-5 times. A typical result at 10% w/w loading, given by FIG. 1, shows large fluctuations, suggesting a continuous agglomeration and de-agglomeration process amongst the particles. This behavior is loosely classified as ‘class 1’ in table 1. For each sample, mean particle diameters were calculated by weighed averaging over all measured intensity distributions of each scan, as reported in table 1 which also gives mean diameter values averaged over all samples.

### Example 2

Dispersions at 5, 10 and 15% w/w loading of Kraft lignin in diethylene glycol were prepared by means of the procedure outlined in example 1. Particles sizes and their distributions were fluctuating as in example 1. Classification and values for mean particle diameters are given in table 1.

### Example 3

Dispersions at 5, 10 and 15% w/w loading of Kraft lignin in polyethylene glycol 200 were prepared by means of the procedure outlined in example 1. Particles sizes and their distributions were fluctuating as in example 1. Classification and values for mean particle diameters are given in table 1.

### Example 4

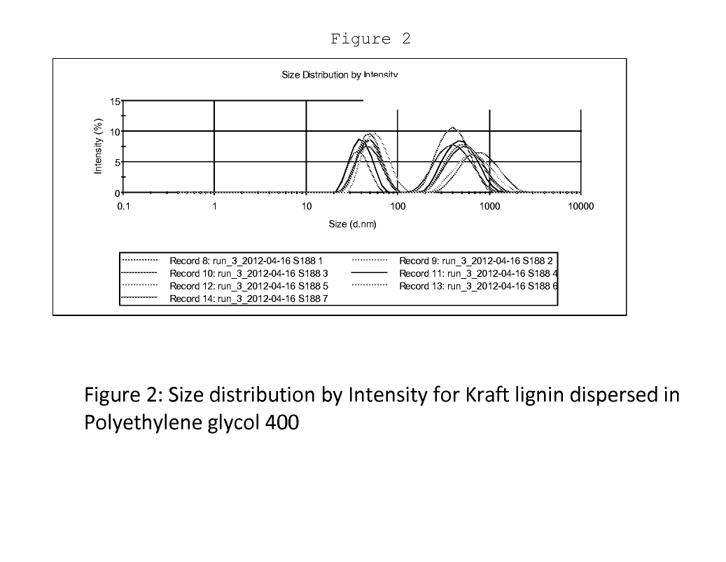

Dispersions at 5, 10 and 15% w/w loading of Kraft lignin in polyethylene glycol 400 were prepared by means of the procedure outlined in example 1. Particles sizes and their distributions exhibited a biphasic pattern which is shown by FIG. 2. This behavior is indicated as ‘class 2’ in table 1 which also gives values for mean particle diameters.

### Example 5

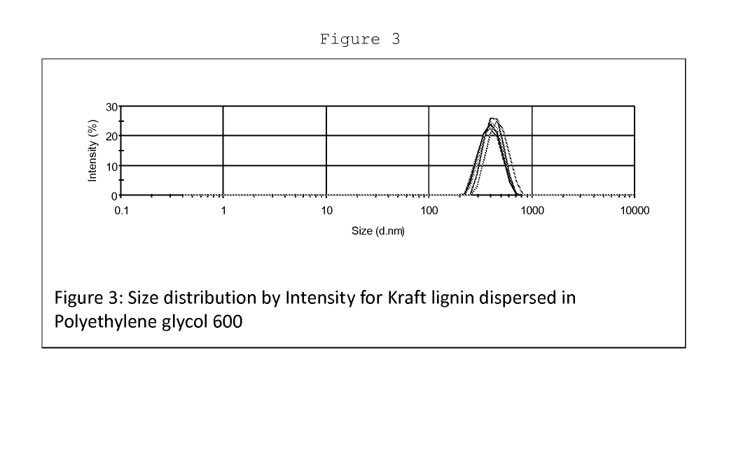

Dispersions at 5, 10 and 15% w/w loading of Kraft lignin in polyethylene glycol 600 were prepared by means of the procedure outlined in example 1. Particles sizes and their distributions revealed a monodisperse behavior which is shown by FIG. 3. This behavior is indicated as ‘class 3’ in table 1 which also gives values for mean particle diameters.

### Example 6

Dispersions at 5 and 10% w/w loading of Kraft lignin in ethanolamine were prepared by means of the procedure outlined in example 1. Particles sizes and their distributions revealed a monodisperse behavior which was accordingly classified in table 1 which also gives values for mean particle diameters.

### Example 7

Dispersions at 5, 10 and 15% w/w loading of Kraft lignin in Voranol™ P1010 (a 1000 MW polypropylene glycol of the Dow Chemical Company) were prepared by means of the procedure outlined in example 1. Particles sizes and their distributions could not be measured due to the turbidity of the dispersions caused by slow precipitation of lignin. This behavior was classified as ‘class 4’ in table 1.

### Example 8

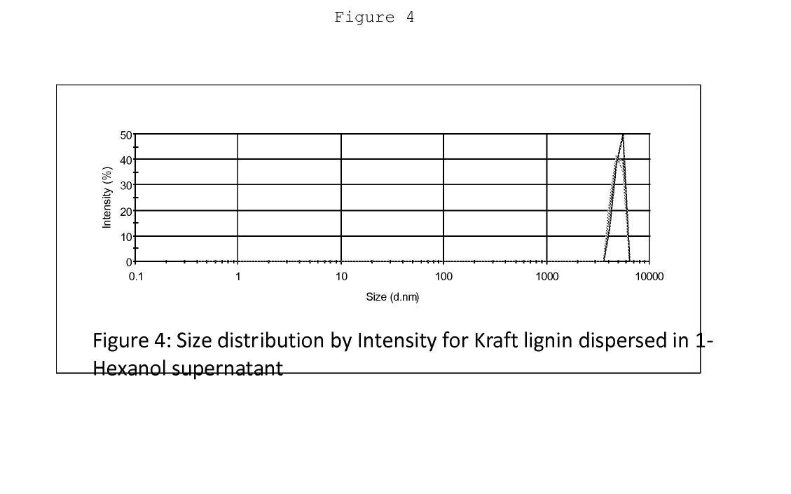

Dispersions at 5 and 10% w/w loading of Kraft lignin in 1-Hexanol were prepared by means of the procedure outlined in example 1. Particles sizes and their distributions could not be measured due to the turbidity of the dispersions caused by fast precipitation (class 4 in table 1). After precipitation, a coloured supernatant was left over which was measured without further dilution. The result is shown by FIG. 4 where very large particle sizes beyond the detection limit of the instrument are observed.

### Example 9

Dispersions at 5 and 10% w/w loading of Kraft lignin in Cyclopentane were prepared by means of the procedure outlined in example 1. Particles sizes and their distributions could not be measured due to the turbidity of the dispersions caused by fast precipitation (class 4 in table 1). After precipitation, a clear supernatant was left over which was measured without further dilution but particles could not be detected.

Table 1 gives a summary of all data, including viscosities of dispersants obtained from literature or from suppliers. Solubility parameters were obtained from the ‘Handbook of solubility parameters and other cohesion parameters’ by A. F. M. Barton, (CRC Press Inc., 1983), or calculated from molecular fragment values using the Hoy-van Krevelen method as described in the same reference.

| | | | | | | Overall |
|---|---|---|---|---|---|---|
| | Solubility | | Nr. of | | Mean | mean |
| | Parameter | Viscosity | samples | | Diameter per | diameter |
| Dispersant | (Mpa^{1/2}) | (mPa · s) | tested | Class | run (nm) | (nm) |
| Ethylene Glycol | 29.90¹ | 16.1 | 3 | 1 | 702, 837, | 1014 |
| | | | | | 1504 | |
| Diethylene | 28.65¹ | 30.2 | 3 | 1 | 866, 990, | 1099 |
| Glycol | | | | | 1440 | |
| Polyethylene | 22.67² | 50.0 | 3 | 1 | 403, 302, | 346 |
| Glycol 200 | | | | | 332 | |
| Polyethylene | 20.56² | 91.0 | 4 | 2 | 351, 332, | 260 |
| Glycol 400 | | | | | 207, 148 | |
| Polyethylene | 19.88² | 135.0 | 2 | 3 | 422, 427 | 425 |
| Glycol 600 | | | | | | |
| Ethanolamine | 27.54¹ | 21.1 | 2 | 3 | 440, 488 | 444 |
| Voranol ™ | 17.40² | 150.0 | 3 | 4 | >1000 (3x) | n.d. |
| P1010 | | | | | | |
| 1-Hexanol | 18.91¹ | 4.58 | 2 | 4 | >1000 (2x) | n.d. |
| Cyclopentane | 16.57¹ | 0.416 | 2 | 4 | >1000 (2x) | n.d. |

Table 1: summary of data from example. Key: 1=value from Barton, 2=calculated by Hoy-van Krevelen method.
The Ethylene glycol (or monoethylene glycol (MEG)) was obtained from ABCR Chemicals
The ethanolamine, 2-aminoethanol or monoethanolamine (MEA) was obtained from Riedel-de Haen
The diethylene glycol (DEG) was obtained from Merck
The Polyethylene glycol 200 (PEG200 or E200) was obtained from Merck. (see PEG 400 and PEG 600 below)
1-Hexanol was obtained from Fluka Chemicals

### Examples of Polyisocyanurate Foams

The applicability of the invention is further demonstrated by examples 10-17, comprising the preparation of polyisocyanurate foams by handmix foaming (which thus was a discontinuous, batch-wise, process). To this end, lignin containing polyol compositions were prepared by weighing a target amount of lignin in a cardboard beaker, addition of the dispersant selected, followed by addition of all other polyol components and additives, except the blowing agent(s). This mixture was subsequently dispersed using a Heidolph DIAX 900 disperser which was operated at two rates, initially at 18800 rpm/min for at least 1 minute to disperse the dry lignin, followed by at least one minute at 25000 rpm to ensure maximum dispersability. The blowing agent was always added last, using the Heidolph stirrer described below, just before mixing the polyol blend with Lupranat M20S from BASF which was invariably used as PMDI.

Handmix foams were prepared using a Heidolph lab. stirrer fitted with timer and rpm counter as follows. After preparing the polyol blends in a carboard beaker, a weighed amount of Lupranat M20S was poured in the beaker. Subsequently, the mixture was stirred for 10 seconds at 4000 rpm, after which the reacting mass was poured into a 20×20×20 cm³ cardboard box where it was allowed to rise freely and cure. Nucleation was recorded in the usual way by visually inspecting the transition to a creamy mass in the box (cream time). The fully developed foam was then probed by a disposable (wooden) spatula to check the formation of strings in the foaming mass. The first appearance of these strings was recorded as ‘string time’. Finally, the same spatula was used to test ‘tackiness’ of the fully risen foam. The first disappearance of tackiness was recorded as ‘tack free’ time. Polyisocyanurate (PIR) foams were selected as the first target to demonstrate the capabilities of the invention which is however not limited to this particular application.

Core density of the foam was measured on eight 5×5×5 cm³ samples cut from the central 10×10×10 cm³ cube of the foam by averaging over their weight:volume ratio. Corrections for buoyancy were not made. Compressive strength was measured similarly on the same samples, by averaging over 4 perpendicular to rise and 4 parallel to rise measurements on a Zwick 1425 Dynamic Mechanical tester traveling at 5 mm/min. The average pressure in kPa needed for 10% compression of the samples was recorded as the compressive strength of the foams. Formulations used are given by table 1 where Polyethylene glycol 400 or mixtures thereof with Polyethylene glycol 600 was invariably used as the dispersant for lignin. Details of the formulations, including various polyols, additives and hydrocarbon blowing agents are specified in table 2, together with data for a reference formulation without lignin. Reactivities, core densities and compressive strength performance of these foams, are given by table 3. They demonstrate that PIR foams of with excellent properties can be made using the lignin dispersions of this invention.

Lupraphen® 8007 is a bifunctional polyesterpolyol based upon dicarboxylic acid. Provider was BASF.
Stepanpol 2402 B is a bifunctional polyester polyol based upon dicarboxylic acid. Provider was Stepan.
The lignin was a kraft lignin obtained internally.
The polyethylene Glycol PEG 400 was Pluriol® E 400 and the provider was BASF.
The Polyethylene Glycol PEG 600 was Pluriol® E 600 and the provider was BASF.
KOSMOS® 75 MEG is a medium viscous catalyst for use when manufacturing foams. It consists of potassium octoate dissolved in ethylene glycol. Provider was Evonik Industries AG.
TEGOAMIN® PMDETA (pentamethyldiethylenetriamine) was provided through Evonik Industries AG.
TEGOAMIN® DMCHA (N,N-dimethylcyclohexyl-amine) was also provided through Evonik Industries AG.
TEGOSTAB® B 8491 is a hydrolysis-resistant polyether polydimethylsiloxane copolymer. Provider was Evonik Industries AG.
TCPP (trade name) is Tris (1-chloro-2-propyl) phosphate and the provider was ICL bearing the trademark Fyrol® PCF for said compound.
Lupranat® M 20 S is a solvent-free product based upon 4,4″-diphenyl-methane-di-isocyanate (MDI) with high functional oligomers and isomers. Provider was BASF.
The cyclopentane and n-pentane were obtained from Alfa Aesar

TABLE 2
lignin-containing formulations for polyisocyanurate foams

| Example nr. | | 10 | 11 | 12 | 13 | 14 | 15 | 16 | 17 |
|---|---|---|---|---|---|---|---|---|---|
| % w/w Lignin in polyol | | 12.6 | 9.9 | 14.5 | 5.0 | 5.0 | 15.5 | 15.5 | 7.6 |
| % w/w Lignin in dispersant | | 21.2 | 17.0 | 24.6 | 64.0 | 63.8 | 69.9 | 69.9 | 17.0 |
| Polyols + | Lupraphen 8007 | 34.04 | 34.04 | 33.96 | 75.40 | 75.22 | 60.84 | 60.78 | |
| OH cpds | Stepanpol 2402 B | | | | | | | | 43.78 |
| | TL018 | 10.51 | 8.08 | 12.04 | 4.09 | 4.05 | 12.09 | 12.09 | 6.00 |
| | PEG400 | 26.00 | 26.10 | 24.36 | 2.30 | 2.30 | 5.21 | 5.20 | 29.20 |
| | PEG600 | 13.06 | 13.32 | 12.46 | | | | | |
| | H2O | 0.72 | 0.71 | 0.73 | 0.75 | 0.73 | 0.75 | 0.72 | 0.75 |
| | Kosmos 75 MEG | 2.40 | 2.39 | 2.42 | 2.39 | 2.41 | 2.44 | 2.60 | 2.40 |
| Additives | Tegoamin PMDETA | 0.20 | 0.18 | 0.17 | 0.16 | 0.17 | 0.16 | 0.17 | 0.14 |
| | Tegoamin DMCHA | 0.31 | | | 0.15 | 0.15 | 0.52 | 0.52 | 0.13 |
| | Tegostab B8491 | 1.81 | 1.88 | 1.87 | 1.62 | 1.60 | 1.64 | 1.68 | 1.79 |
| | TCPP | 16.02 | 16.04 | 16.02 | 15.96 | 16.00 | 16.01 | 16.03 | 17.12 |
| Blowing | n-pentane | 17.69 | 13.73 | 13.84 | 6.84 | 4.55 | 6.68 | 4.53 | 6.86 |
| agents | Cyclopentane | | | | 6.84 | 4.55 | 6.68 | 4.53 | 6.86 |
| pMDI | Lupranate M20S | 156.79 | 128.71 | 155.56 | 158.37 | 160.77 | 159.2 | 159.82 | 157.54 |

| | | | | | | | | |
|---|---|---|---|---|---|---|---|---|
| Isocyanate index | 2.63 | 2.18 | 2.64 | 2.63 | 2.69 | 2.83 | 2.85 | 2.60 |

TABLE 3
physical properties of lignin-containing polyisocyanurate foams

| Example nr. | 10 | 11 | 12 | 13 | 14 | 15 | 16 | 17 |
|---|---|---|---|---|---|---|---|---|
| Cream time (s) | 14 | <10 | 24 | 8 | 7 | 8 | 9 | 9 |
| String time time (s) | 22 | 40 | 108 | 64 | 18 | 22 | 31 | 31 |
| Tack-free time (s) | 36 | ? | ? | 106 | 25 | 27 | 45 | 45 |
| Core density (g/ltr) | 26.8 | 30.0 | 30.1 | 29.1 | 37.8 | 29.7 | 35.7 | |
| Compressive strength // (kPa) | 162 | 202 | 199 | 228 | 309 | 214 | 261 | |
| Compressive strength ⊥ (kPa) | 56 | 57 | 56 | 73 | 108 | 74 | 104 | |
| Lambda (10 deg. C., mW/mK) | | | | | | | | 23.85 |
| Flame height D IN 4102 B2 (cm) | | | | | | | | 10.50 |

Reactivities, core densities, compressive strength performance of foams from examples 10-16, are given by table 3. They demonstrate that PIR foams of excellent reactivity and mechanical performance properties can be made using the lignin dispersions of this invention. Example nr. 17 is included in this table to demonstrate that thermal insulation performance as well as flame retardancy of the foams is comparable to the reference. The lambda value of 23.85 is better than reference whilst the flame height of 10.50 cm in the DIN 4102 indicates that this foam satisfies the DIN B2 classification.

Various embodiments of the present invention have been described above but a person skilled in the art realizes further minor alterations, which would fall into the scope of the present invention. The breadth and scope of the present invention should not be limited by any of the above-described exemplary embodiments, but should be defined only in accordance with the following claims and their equivalents. For example, any of the above-noted compositions or methods may be combined with other known methods. Other aspects, advantages and modifications within the scope of the invention will be apparent to those skilled in the art to which the invention pertains.

1. A composition in the form of a dispersion, comprising one or more dispersants, and lignin, wherein said lignin has an average particle size of from about 100 nm to about 2000 nm, and wherein said dispersants has a solubility parameter of from about 18 to about 30 MPa1/2 and a viscosity of from about 15 mPas to about 20,000 mPas.

2. A composition according to claim 1 wherein said lignin is a Kraft lignin.

3. A composition according to claim 1 wherein said dispersant is a polyol.

4. A composition according to claim 3 wherein the polyol is PEG having a molecular weight of from about 100 to about 5000.

5. A composition according to claim 3 wherein said polyol comprises a mixture of different PEGs, one PEG having a molecular weight of about 400 and one PEG having a molecular weight of about 600.

6. A composition according to claim 1 also comprising one or more alkanolamines.

7. A composition according to claim 1 also comprising one or more flame retarding agents.

8. Use of a composition according to claim 1 for making foams, rubbers, adhesives, reactive fillers or for use as a filling agent.

9. A method for manufacturing a composition in the form of a dispersion, according to claim 1, comprising the following steps:
a. i) providing a lignin,
b. ii) adding one polyol or a mixture of polyols, and
c. iii) mixing said components thus providing said composition.

10. A method according claim 9 wherein one or more flame retarding agents are added before mixing.

11. A method according claim 9 wherein said mixing is a high shear mixing of at least about 1000 rpm.

12. A composition in the form of a dispersion obtainable by a method according to claim 9.

13. A method for manufacturing a foam comprising the following steps:
a. providing a composition according to claim 1,
b. adding one or more blowing agents to said composition,
c. adding one or more additives,
d. adding iso-cyanate to said composition,
e. stirring the mixture obtained in step d) and
f. conveying the stirred mixture in step e) into a mould to provide a foam continuously or discontinuously.

14. A method according to claim 13 wherein said one or more additives may be selected from the group consisting of one or more surfactants, one or more polyurethane catalysts, one or more flame retarding agents, or combinations thereof.

15. A method according to claim 13 wherein said one or more blowing agents are one or more hydrocarbon compounds selected from i-pentane, n-pentane and cyclopentene or a combination thereof.

16. A method according to claim 13 wherein one or more hydroxyl-containing compounds or one more catalysts are added before addition of said one or more blowing agents.

17. A foam obtainable by the method according to claim 13.

18. Use of a foam according to claim 17 in the building and construction segment, for thermal insulation, in automotive applications, appliances, footwear, or in furniture or bedding applications.

19. A composition according to claim 1 wherein said lignin has an average particle size in a range from 200 to 600 nm.

20. A composition according to claim 1 wherein said dispersants have a viscosity of from 20 mPas to 500 mPas.
